(19) United States
(12) Patent Application Publication
(10) Pub. No.: US 2015/0246632 A1
(43) Pub. Date: Sep. 3, 2015

(54) Kwik Tarp covering system

(71) Applicant: Robert A. Jones, JR., Harvey, IL (US)

(72) Inventor: Robert A. Jones, JR., Harvey, IL (US)

(21) Appl. No.: 14/194,725

(22) Filed: Mar. 1, 2014

(51) Int. Cl. B60P 7/04

(52) U.S. Cl. CPC B60P 7/04

(57) ABSTRACT

This invention relates to a tarp covering system that is adapted to be moved from an opened position to a closed position along the top opening of a trailer through the use of a wheel system which slides along the interior floor of a track. The wheels are adapted to use sprockets and can slide back and forth along the tracks. A manual actuator can be used to facilitate the opening and closing of the tarp. In a motorized embodiment of the system, chains can be used to facilitate the movement of the wheels.

### BACKGROUND OF THE INVENTION

1. Field of Invention

The present invention relates to a trap covering system that is used to cover an open top of a trailer.

2. Description of Related Art

MANY times tractors-trailers haul various debris waste and other loose items within the trailer. Tractor trailers with open top trailers may be used for either short or long distance transport and Normally require a covering over the contents to avoid any debris within the trailer from flying out of The trailer onto the roadway. many trailers have a manual system that is utilized to cover the open top

Of the trailer during transport. Occasionally this covering involves the use of pulley systems or a Manually tie down covering over the trailer through the use of a tarp that is tied down with bungees Cords. The manual covering of the trailer may be time-consuming and not safe therefor it would be Advantageous to have a system designed to conveniently and efficiently cover the opening of a trailer With a trap. The current systems availably are limited in terms of automated tarp covering available For trailer 30′-48′ long.

### BRIEF DESCRIPTION OF DRAWINGS

FIG. 1 depicts a component view of a manual tarp covering system in accordance with the present Invention.

FIG. 2 depicts a component view of a motorized tarp covering system according to the present Invention.

FIG. 3 depicts a frontal view of the tarp covering system used in accordance with the present Invention over a trailer.

FIG. 4 depicts a C-Track in accordance with the present invention.

FIG. 5 depicts the side of a trailer plus part of the top to show C-Track right side elevated View there of left side being a mirror image.

### DETAILED DESCRIPTION

The present invention relates to a tarp covering system that utilizes C-Tracks for the movement of a Tarp covering system. The tarp covering system according to the present invention places C-TRACKS along the inside length of a trailer. The C-TRACK receives the wheels that transfer through THE C-TRACK on each side of the trailer walls. This feature allows for the user to easily pull the tarp over The opening of a trailer, motors on the electric kwik tarp allow the tarp to open and close from the Inside of cab.

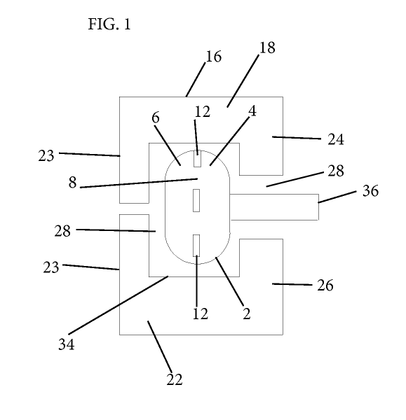

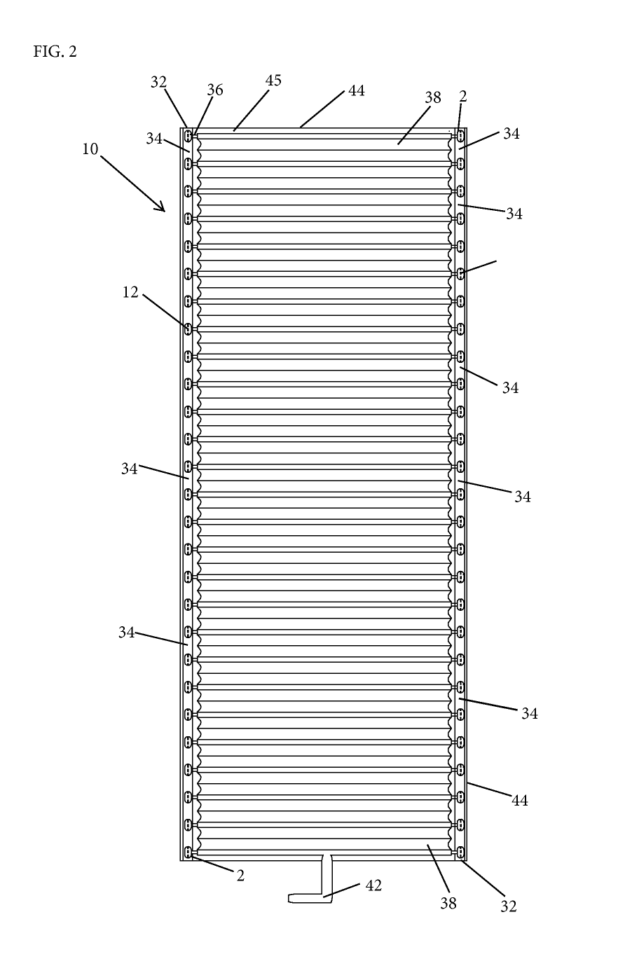

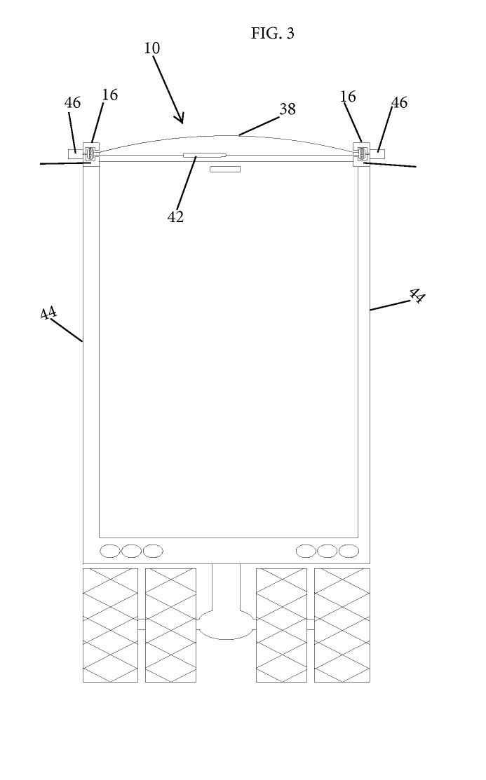

In reference to FIG. 1, a component view of a manual tarp covering system 100 in Accordance with the present invention depicted. The manual tarp covering system 100 includes tracks 40,42. these tracks 40,42 are placed upon the top side lengths of a trailer. The tracks include a C-TRACK 45, which is shown in FIG. 1. The C-TRACK runs along each side of the trailer walls and receives wheels 37 that extend from driver rods 34 that go across the width of the tarp 35. the tarp 35 Therefore may be pulled through the C-TRACK 45 and provide for a covering of a trailer. The tarp 35 Is traverse one end to another. FIG. 2 depicts further components related to a motorized tarp Covering system according to present invention.

The tarp covering system shown in FIG. 2 includes motors 20,22 at the ends of the driver rods Connected to tarp 35 at the extended end motors 24,26 are connected to driver rods depicted on each Side of tarp 35. the motors provide a means to roll the tarp over the trailer opening through the C-TRACKS on each side of trailer walls they provide for an automated means for the placement of the Tarp over the opening. FIG. 1 depicts a manual system that enables the user to simply pull the Tarp through the C-TRACKS 45 by using a driver rod swivel 33 shown at FIG. 1

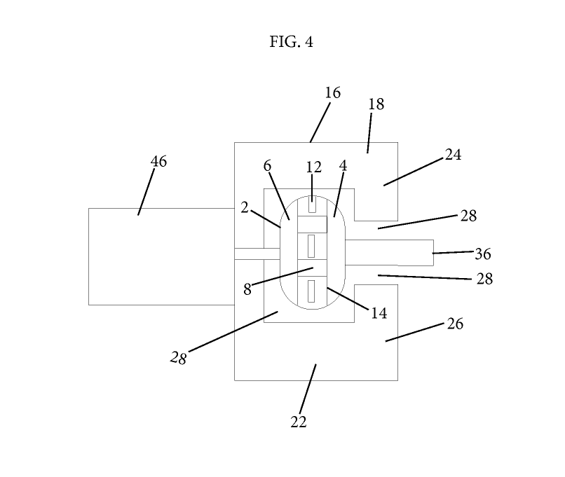

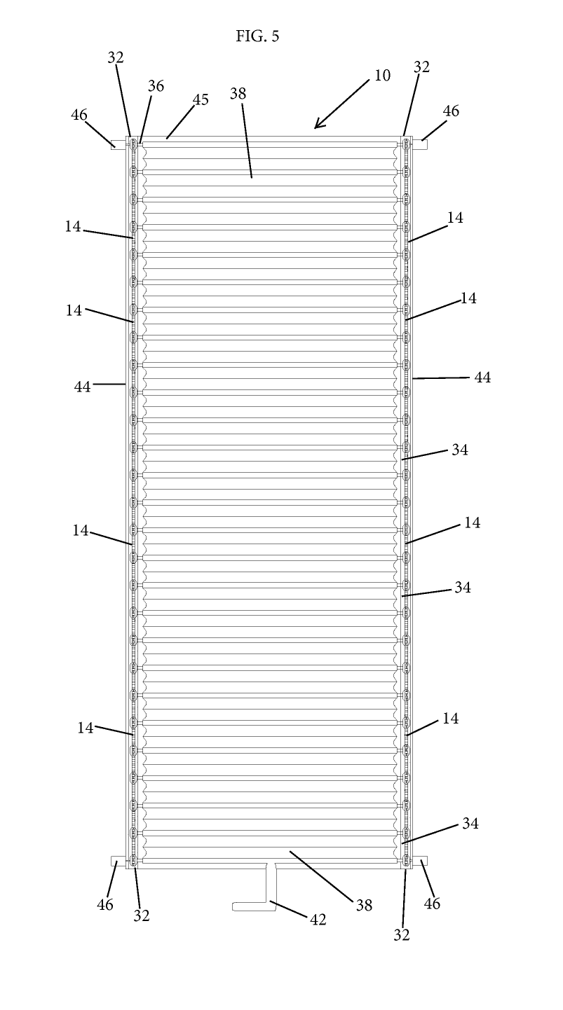

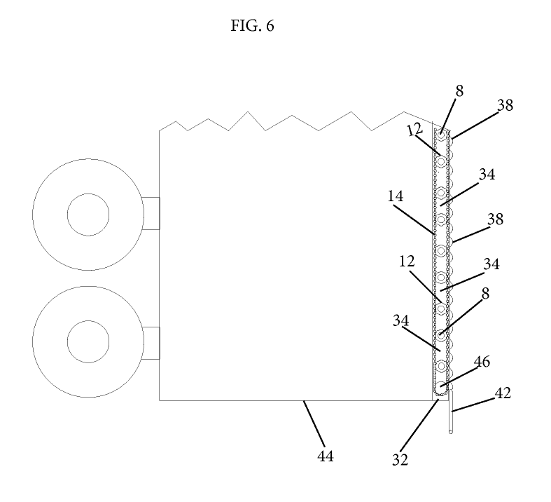

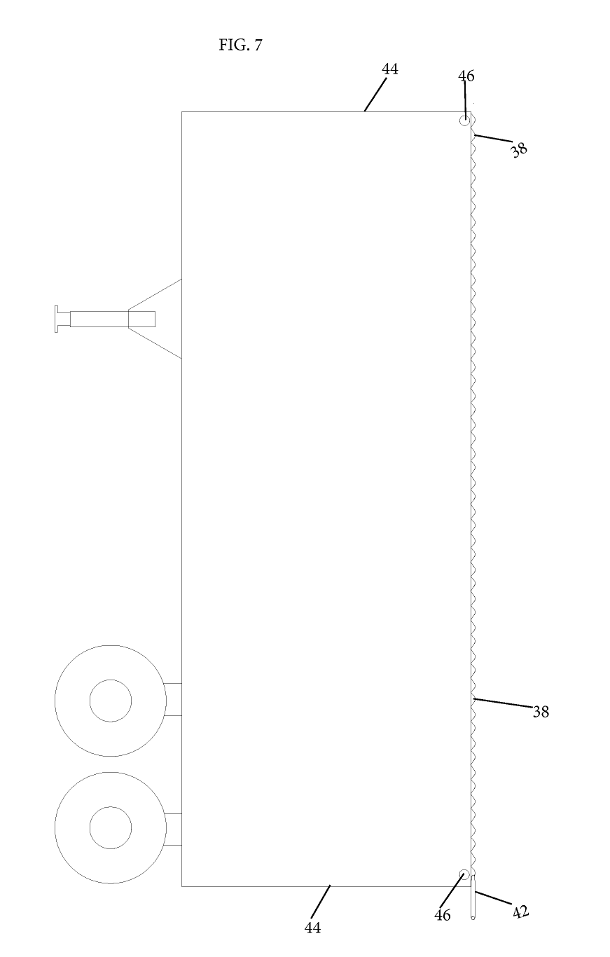

A sectional view of a trailer 60 utilizing the tarp 35 is depicted in FIG. 3. As shown a C-TRACK 45 Is provided on each side of trailer walls shown in FIG. 3. Wheels extending from Driver rods are Engaged in each respective C-TRACK 45 provided on each side of trailer 60 top of trailer. A close-up Of the engagement of the wheels 37 within the C-TRACK 45 is depicted in FIG. 4. This shows how The C-TRACK enables the wheels to transfer through each rail and secure the wheels within each C-TRACK for movement back and forth and keep debris off C-TRACK. This tarp system in accordance With the present invention enables the user to use automated or manual means for covering a trailer.

This system provides an efficient, safe and effective means to cover a trailer and therefore alleviate Bungees and the tying down of other manual means that are available for covering a trailer 30′-48′ long. The kwik tarp invention has been shown and described in what I considers to be the most practical And preferred embodiments

What is claimed is:

1. A KWIK TRAP covering system comprising:
a. DRIVER RODS
b. DRIVER ROD SWIVEL
c. C-TRACKS, positioned the length of trailer.
d. wheel with sprocket, for the chains (electric tarp)
e. tarp, where the tarp includes a plurality of driver rods and wheels extending from each end of each driver rod, where the wheels engage each perspective C-TRACK during movement; and
f. a means to extend and retract the tarp between an extended position and a retracted position.

2. The tarp covering system according to claim 1, where the means to extend and retract includes a Driver rods swivel.

3. The tarp covering system according to claim 1, where the means to extend and retract includes Motors that engage movement for the driver rods.
